(19) United States
(12) Patent Application Publication
(10) Pub. No.: US 2026/0208427 A1
(43) Pub. Date: Jul. 23, 2026

(54) METHOD AND APPARATUS FOR THE PRODUCTION OF PLASTIC CONTAINERS

(71) Applicant: SACMI IMOLA S.C., Imola (IT)

(72) Inventors: Alberto DI GIACOMO, Imola (IT); Fabrizio PUCCI, Castel Guelfo Di Bologna (IT); Fiorenzo PARRINELLO, Medicina (IT); Marco CORRADI, Imola (IT)

(21) Appl. No.: 19/141,799

(22) PCT Filed: Dec. 6, 2023
(86) PCT No.: PCT/EP2023/084569

§ 371 Date: Jun. 20, 2025

(30) Foreign Application Priority Data
Dec. 21, 2022 (IT) 102022000026220

(51) Int. Cl. B29C 49/48; B29L 31/00; B65D 1/26; B65D 1/44; B65D 21/02

(52) U.S. Cl. CPC B29C 49/4802; B29C 49/487105; B65D 1/265; B65D 1/44; B65D 21/0233; B29C 2049/4879; B29L 2031/7132

(57) ABSTRACT

A method for the production of containers including a step of molding a substantially cylindrical preform having a mouth and a preform body having a side wall and a bottom using a mold including a female mold part and a male mold part, and a step of blow-molding the preform to provide a container, wherein the male mold part is provided with at least one corrugated portion designed to provide the internal surface of the preform body arranged proximate to the mouth, the corrugated portion being designed to provide a first internal surface of the preform body that is at least equal to 30% of the surface of the side wall of the preform body, the first internal surface having an Rmc [%] between 1% and 12%.

### CROSS-REFERENCE TO RELATED APPLICATIONS

This application is a 35 U.S.C. § 371 National Stage patent application of no. PCT/EP2023/084569, filed on 6 Dec. 2023, which claims the benefit of Italian patent application no. 102022000026220, filed on 21 Dec. 2022, the disclosures of which are incorporated herein by reference in their entirety.

### TECHNICAL FIELD

The present disclosure relates to a method and an apparatus for the production of plastic containers.

### BACKGROUND

A rather common problem in apparatuses for the production and storage of plastic containers, typically shaped like a vase or cup, is related to the difficulty of properly stacking and/or unstacking the containers produced due to friction between respective portions of the internal surface of the container arranged below and the external surface of the container that is fed from above to be stacked and lifted to be unstacked.

In order to try to obviate this drawback, an attempt has been made to increase the release precision of the containers and to act to generically try to reduce the friction between the internal and external surfaces of the containers to be stacked.

### SUMMARY

The aim of the present disclosure is to provide a method and an apparatus for the production of plastic containers that is capable of improving the background art in one or more of the above aspects.

Within this aim, the disclosure provides a method and an apparatus for the production of plastic containers that significantly reduces the risk of jamming during the stacking and/or unstacking of the containers produced.

The present disclosure further devises a method and an apparatus for the production of plastic containers that allows to increase the productivity of the apparatus.

Not least feature of the disclosure is to provide a method and an apparatus for the production of plastic containers that is highly reliable, relatively easy to provide, and at competitive costs.

This aim, as well as these and other advantages that will become better apparent hereinafter, are achieved by providing a method and an apparatus for the production of plastic containers according to the independent claim, optionally provided with one or more of the characteristics of the dependent claims.

### BRIEF DESCRIPTION OF THE DRAWINGS

Further characteristics and advantages of the disclosure will become better apparent from the description of some preferred, but not exclusive, embodiments of the method and the apparatus for the production of plastic containers according to the disclosure, illustrated by way of non-limiting example in the accompanying drawings, wherein:

FIG. 1 is a lateral elevation view of a preform obtained by means of the molding step of the method according to the disclosure;

FIG. 2 is a lateral elevation view of a container obtained by means of the preform blow-molding step; and

FIG. 3 is a lateral elevation view of mutually stacked containers.

### DETAILED DESCRIPTION OF THE DRAWINGS

With reference to the cited figures, the present disclosure relates to a method for the production of containers 20 and specifically plastic containers.

The containers 20 advantageously have a cup- or tumbler-like shape so that they can be mutually stacked (as shown in FIG. 3).

The method according to the disclosure comprises a step of molding a substantially cylindrical preform 10 which comprises a mouth 11 and a preform body 12.

The preform body 12 comprises a side wall and a bottom.

The molding step comprises, for example, molding by injection or compression or by compression-injection.

The molding step is performed by means of a mold comprising a female mold part and a male mold part.

After the molding step, the method provides for a step of blow-molding the preform 10 to provide a container 20.

According to the present disclosure, the male mold part has at least one corrugated portion designed to provide the internal surface 12a of the preform body 12 arranged proximate to the mouth 11.

The corrugated portion is, in particular, designed to provide a first internal surface 12a of the preform body 12 that is at least equal to 30% of the surface of the side wall of said preform body 12.

The preform 12 forms at least one second internal surface 12b extending from the opposite side of the first internal surface 12a with respect to the mouth 11.

Conveniently, the preform 12 also forms a third internal surface 12c extending from the opposite side of the second internal surface 12b with respect to the first internal surface 12a.

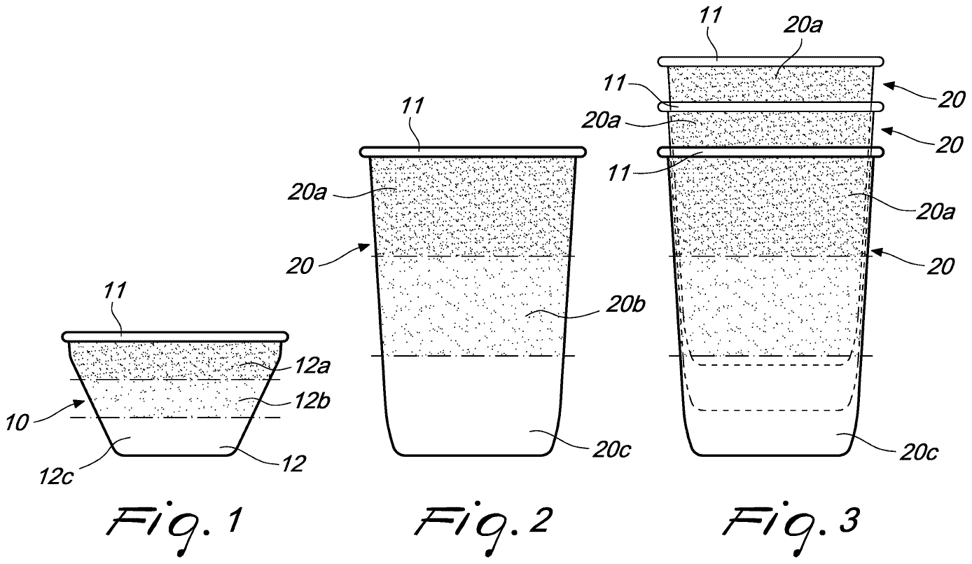

In practice, as shown in FIG. 1, the first internal surface 12a is extended proximate to the mouth 11 of the preform 10, the third internal surface 12c is extended proximate to the bottom of preform 10, and the second internal surface 12b is extended in an intermediate position between the first internal surface 12a and the third internal surface 12c.

The first internal surface 12a has an Rmc [%] comprised between 1% and 12%.

The blow-molding step is, in turn, adapted to provide a container 20 having the respective first internal region 20a provided starting from the first internal surface 12a of the preform body 12 having an Rmc [%] comprised between 3% and 30%.

Rmc [%] is understood to refer to the percentage of load-bearing surface.

Its definition and calculation method is given in the ISO 21920-2:2021 standard and has substantially replaced what was referenced as Rmr in the previous, now withdrawn, UNI EN ISO 4287:2002 standard.

The parameter Rmc can also be defined as the length of the resting contact surface expressed as a percentage of the assessment length, at a depth “c” below the highest peak.

It is also possible to derive Rmc as the length of the resting contact surface expressed as a percentage of the assessment length, at a height “c” above the midplane.

Advantageously, the first internal surface 12a has an Rmc [%] (measured at a distance “c” above the midplane) comprised between 1% and 10%, and more preferably comprised between 3% and 7%.

In the latter case, the blow-molding step is adapted to provide a container 20 having the respective internal region 20a that is provided starting from the first internal surface 12a of the preform body 12 having an Rmc [%] comprised between 4% and 28%.

Conveniently, the corrugated portion is designed to provide a first internal surface 12a of the preform body 12 that is at least equal to 50% of the side wall surface of the preform body 12.

The corrugated portion is obtained by sandblasting the male mold part.

Of course, there is nothing to prevent obtaining the corrugated portion of the male mold part by means of other abrasion techniques, even of the chemical type.

The method according to the disclosure provides, after the blow-molding step, a step of stacking the containers 20 inside each other, oriented with their respective mouths 11 directed upward.

According to a further aspect, the present disclosure relates to an apparatus for producing containers 20 which comprises a mold for molding a substantially cylindrical preform 10 comprising a mouth 11 and a preform body 12 comprising a side wall and a bottom.

The mold comprises a female mold part and a male mold part.

The apparatus furthermore comprises a device for blow-molding preform 10 in order to provide a container 20.

In particular, the male mold part has at least one corrugated portion designed to provide the internal surface 12a of the preform body 12 arranged proximate to the mouth 11.

The corrugated portion is designed to provide a first internal surface 12a of the preform body 12 at least equal to 30% of the surface of the side wall of the preform body 12.

The first internal surface 12a has an Rmc [%] comprised between 1% and 12%.

The blow-molding step is also adapted to provide a container 20 having the respective internal region 20a provided starting from the first internal surface 12a of the preform body 12 having an Rmc [%] comprised between 3% and 30%.

Conveniently, the corrugated portion is designed to provide a first internal surface 12a of the preform body 12 that is at least equal to 50% of the surface of the side wall of the preform body 12.

The corrugated portion is obtained by sandblasting the male mold part.

According to a further aspect, the present disclosure relates to a container 20 characterized in that it is obtainable by means of a method according to the above description.

To complete the data provided in the description, the data on the corrugations of the preform 12 and the container 20 in the various regions of two different samples are provided hereinafter.

| | Rmc [%] calculated |
|---|---|
| | with “c” above |
| Sample 1 | the midplane |
| Preform region 12a | 6% average value |
| | 1.2%-11% range |
| Container region 20a | 15% average value |
| | 4%-30% range |
| Container region 20b | 16% average value |
| | 2.5%-30% range |
| Container region 20c | 17% average value |
| | 5%-27% range |

| | Rmc [%] calculated |
|---|---|
| | with “c” above |
| Sample 2 | the midplane |
| Preform region 12a | 7.6% average value |
| | 4%-12% range |
| Container region 20a | 30% average value |
| | 22%-40% range |
| Container region 20b | 16.7% average value |
| | 9%-27% range |
| Container region 20c | 12.7% average value |
| | 4%-20% range |

In practice it has been found that the disclosure achieves the intended aim and advantages, providing a method and an apparatus for the production of containers in which the risks of incorrect stacking and/or unstacking are extremely reduced, with no discernible increase in apparatus costs or reduction in production speed.

The disclosure thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

1-10. (canceled)

11. A method for the production of containers comprising a step of molding a substantially cylindrical preform comprising a mouth and a preform body comprising a side wall and a bottom using a mold comprising a female mold part and a male mold part, and a step of blow-molding said preform to provide a container, wherein said male mold part is provided with at least one corrugated portion designed to provide the internal surface of the preform body arranged proximate to the mouth, said corrugated portion being designed to provide a first internal surface of the preform body that is at least equal to 30% of a surface of a side wall of said preform body, said first internal surface having an Rmc [%] comprised between 1% and 12%, said blow-molding step being adapted to provide a container having a respective internal region provided starting from said first internal surface of said preform body having an Rmc [%] comprised between 3% and 30%.

12. The method according to claim 11, wherein said first internal surface has an Rmc [%] comprised between 1% and 10%, said blow-molding step being adapted to provide a container having the respective internal region provided starting from said first internal surface of said preform body having an Rmc [%] comprised between 4% and 28%.

13. The method according to claim 11, wherein said Rmc [%] is calculated as defined in the ISO 21920-2:2021 standard.

14. The method according to claim 11, wherein said corrugated portion is designed to provide a first internal surface of the preform body at least equal to 50% of the surface of the side wall of said preform body.

15. The method according to claim 11, wherein said corrugated portion is obtained by sandblasting said male mold part.

16. The method according to claim 11, further comprising a step of stacking said containers inside each other, oriented with respective mouths thereof directed upward.

17. An apparatus for producing containers, comprising a mold for molding a substantially cylindrical preform comprising a mouth and a preform body comprising a side wall and a bottom, said mold comprising a female mold part and a male mold part, and a device for blow-molding said preform to provide a container, characterized in that said male mold part is provided with at least one corrugated portion designed to provide the internal surface of the preform body arranged proximate to the mouth, said corrugated portion being designed to provide a first internal surface of the preform body that is at least equal to 30% of the surface of the side wall of said preform body, said first internal surface having an Rmc [%] comprised between 1% and 12%, said blow-molding step being adapted to provide a container having the respective internal region provided starting from said first internal surface of said preform body having an Rmc [%] comprised between 3% and 30%.

18. The apparatus for producing containers according to claim 17, wherein said corrugated portion is designed to provide a first internal surface of the preform body that is at least equal to 50% of the surface of the side wall of said preform body.

19. The apparatus for producing containers according to claim 17, wherein said corrugated portion is obtained by sandblasting said male mold part.

20. A container made using a method according to claim 11.
